(19) United States
(12) Patent Application Publication
(10) Pub. No.: US 2010/0303450 A1
(43) Pub. Date: Dec. 2, 2010

(54) PLAYBACK CONTROL

(75) Inventor: Jonathan Davies, Bristol (GB)

Correspondence Address: Perman & Green, LLP, 99 Hawley Lane, Stratford, CT, 06614, US

(73) Assignee: NOKIA CORPORATION, Espoo (FI)

(21) Appl. No.: 12/474,478

(22) Filed: May 29, 2009

(51) Int. Cl. H04N 5/91; G06F 3/041; G06F 3/01

(52) U.S. Cl. 386/349; 345/173; 715/719

(57) ABSTRACT

An apparatus includes a controller, wherein the controller is arranged to display a status bar, display an indicator head on the status bar, receive input indicating a position corresponding to the indicator head, and to determine if a media file is currently being played and if so pause the playback and if not to activate the playback in response to the received input.

### BACKGROUND

1. Field

The present application relates to a user interface, an apparatus and a method for control of playback of a media file, and in particular to a user interface, an apparatus and a method for quick access to playback controls of a media file.

2. Brief Description of Related Developments

More and more electronic devices such as mobile phones, MP3 players, Personal Digital Assistants (PDAs) and computers both laptops and desktops are being used to play various media files such as video files, slide shows and music files.

When a user is viewing or playing a media file he should not be interrupted from the media content by having to search for a function feature or move his focus to find a function feature. Another problem exists in that if a control is not easy to find it is perceived as annoying to both a user and also to his surroundings. For example if a pause or mute control can not be found quickly a loud sound setting may be highly disturbing in a silent area.

An apparatus that allows fast and easy access to functions for media files would thus be useful in modern day society

### SUMMARY

On this background, it would be advantageously to provide a user interface, an apparatus and a method that overcomes or at least reduces the drawbacks indicated above by providing an apparatus according to the claims.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2a and b are views of each an apparatus according to an embodiment,

FIG. 3 is a block diagram illustrating the general architecture of an apparatus of FIG. 2a in accordance with the present application,

FIG. 4a to h are screen shot views of an apparatus or views of an application window according to an embodiment,

FIG. 5a, b and c are application views of an apparatus or views of an application window according to an embodiment, and

FIG. 6 is a flow chart describing a method according to an embodiment of the application.

### DETAILED DESCRIPTION OF THE DISCLOSED EMBODIMENTS

In the following detailed description, the user interface, the apparatus, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

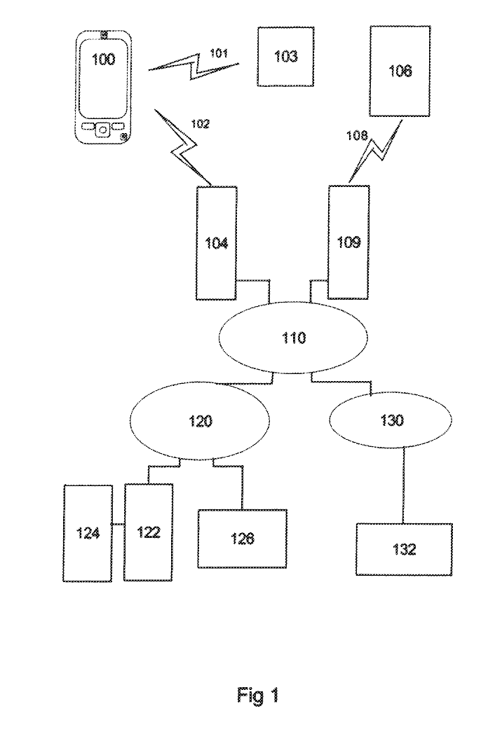

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Speciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a laptop or desktop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an internet network of which the telecommunications network described above may be a part of.

It should be noted that even though the teachings herein are described solely to wireless networks it is in no respect to be limited to wireless networks as such, but it to be understood to be usable in the Internet or similar networks.

It should thus be understood that an apparatus according to the teachings herein may be a mobile communications terminal, such as a mobile telephone, a media player, a music player, a video player, a personal digital assistant, a laptop as well as a stationary device such as a desktop computer or a server.

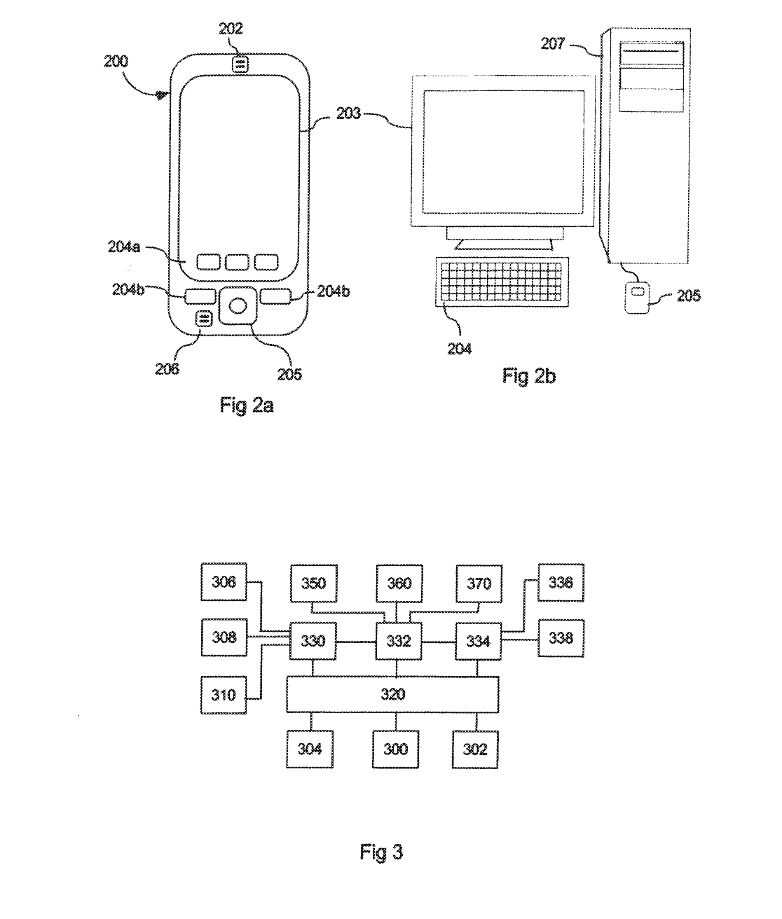

An embodiment 200 of the mobile terminal 100 is illustrated in more detail in FIG. 2a. The mobile terminal 200 comprises a speaker or earphone 202, a microphone 206, a main or first display 203 and a set of keys 204 which may include keys such as soft keys 204b, 204c and a joystick 205 or other type of navigational input device. In this embodiment the display 203 is a touch-sensitive display also called a touchdisplay which displays various virtual keys 204a.

An alternative embodiment of the teachings herein is illustrated in FIG. 2b in the form of a computer which in this example is a desktop computer 200. The computer has a screen 203, a keypad 204 and navigational means in the form of a cursor controlling input means which in this example is a computer mouse 205.

It should be noted that a computer can also be connected to a wireless network as shown in FIG. 1 where the computer 200 would be an embodiment of the device 100.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a media file player 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The MMI 334 also includes one or more hardware controllers, which together with the MMI drivers cooperate with the first display 336/203, and the keypad 338/204 as well as various other Input/Output devices such as microphone, speaker, vibrator, ringtone generator, LED indicator, etc.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

In the following description it will be assumed that the display is a touch display and that a tap is performed with a stylus or finger or other touching means tapping on a position on the display. It should be noted that a tap may also be included by use of other pointing means such as a mouse or touch pad controlled cursor which is positioned at a specific position and then a clicking action is performed. This analogy is commonly known in the field and will be clear to a skilled person. In the description it will be assumed that a tap input comprises a clicking action at an indicated position.

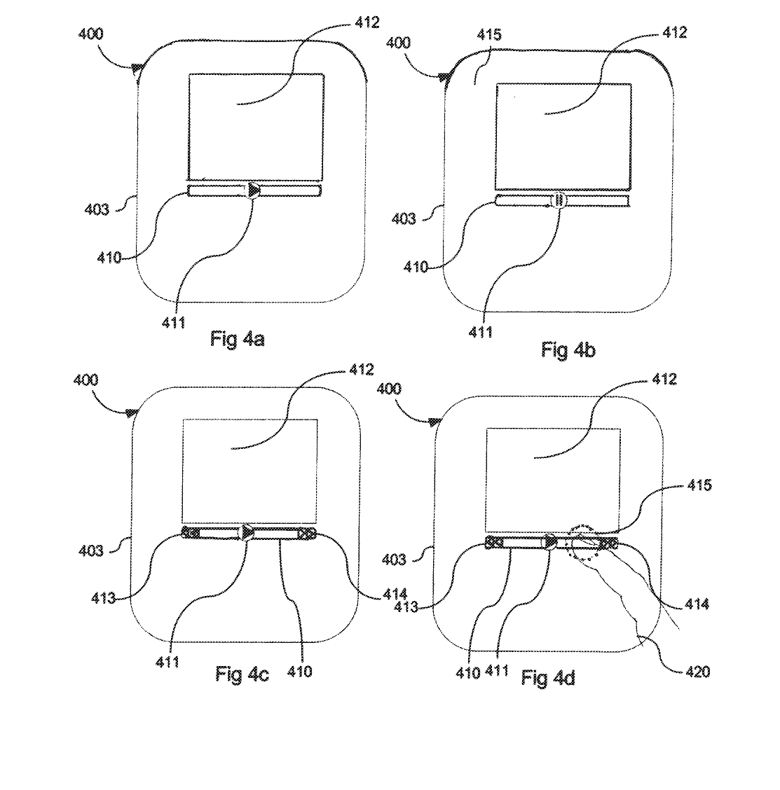

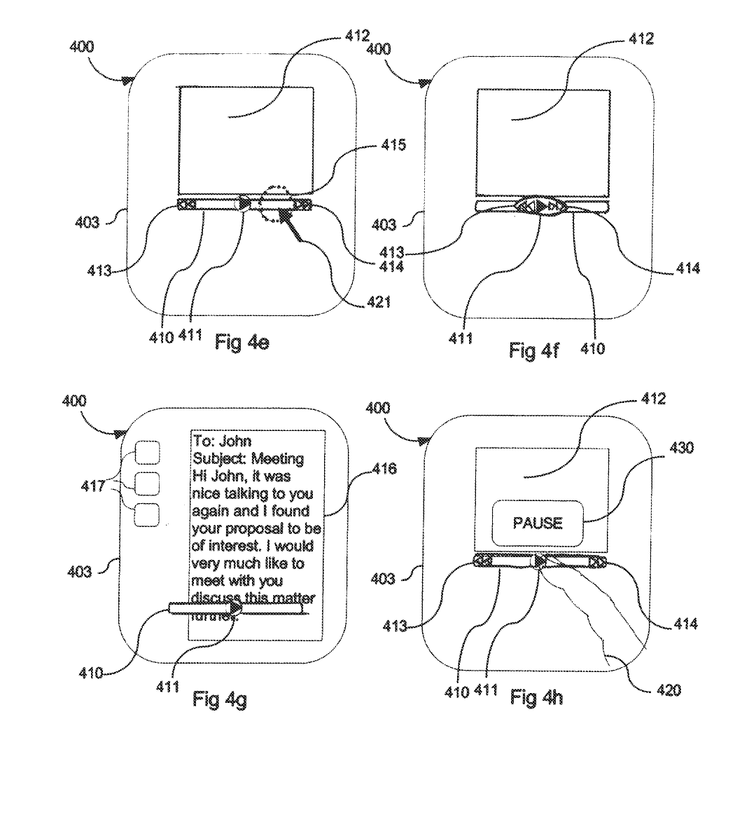

FIG. 4 show a screen shot view of an apparatus 400 according to the teachings herein. It should be noted that such an apparatus is not limited to a mobile phone, but can be any apparatus capable of playing media files.

It should be noted that the media files may be stored on said apparatus or remotely at another position or in an other apparatus. A media file may also be downloaded while it is being played, so called streaming.

Examples of such apparatuses are computers, media players, mobile phones, personal digital assistants (PDA), digital cameras, navigation devices such as GPS (Global Positioning System) devices, game consoles electronic books, Digital Video Disc players, radio sets, television sets, photo and video cameras and electronic dictionaries.

The apparatus 400 has a display 403, which in this embodiment is a touch display.

A controller is configured to display a status bar or play progression indicator 410 on the display 403. The status bar comprise an indicator head 411 which moves along the status bar to indicate where in the file or possibly series of files (such as a play list or a slideshow) the current playback is or in other words how far the playback has progressed.

In this example the indicator head is marked with a triangular shape commonly used to indicate a play function, see FIG. 4a.

A controller is configured to receive input indicating a location corresponding to the indicator head.

As such input is received the controller is configured to determine whether the media file is currently playing and if so to cause the playback to be paused.

In one embodiment the graphical indication on the indicator head 411 is changed to indicate visually to a user that the playback is paused, see FIG. 4b. In this example the graphical indicator are two parallel bars.

If it is determined by the controller that the media file is not currently playing (i.e. either paused or stopped or not started yet) the controller is configured to activate the playback.

The controller is configured to activate (possibly re-activate) the playback at the position in the media file which corresponds to the position of the indicator head 411 on the status bar 410.

By realizing that by incorporating the play/pause control in the indicator head display space can be saved while at the same time a user is well-informed of how to control an application. The user will also not be forced to make (repeated) long movements over the display area to access the different controls. This a problem that is generally perceived as being annoying and consumes a lot of cognitive effort in that a new control has to be searched for and found to execute a command.

The combination of the progress indicator and play/pause button couples the playback functionalities into a cognitive unit and makes the feature highly intuitive to use and to find. It is also prima facia understandable how the feature is to be used and how it its functionality is linked to the file.

In one example embodiment the controller is arranged to display the content of the media file in a viewer area 412.

The placement of the status bar 410 on the display 403 is a matter of design choice.

In one embodiment the status bar 410 is incorporated into the display area 412.

In one embodiment the status bar 410 is positioned adjacent the display area 412.

In one embodiment the status bar 410 is positioned separately from the display area 412.

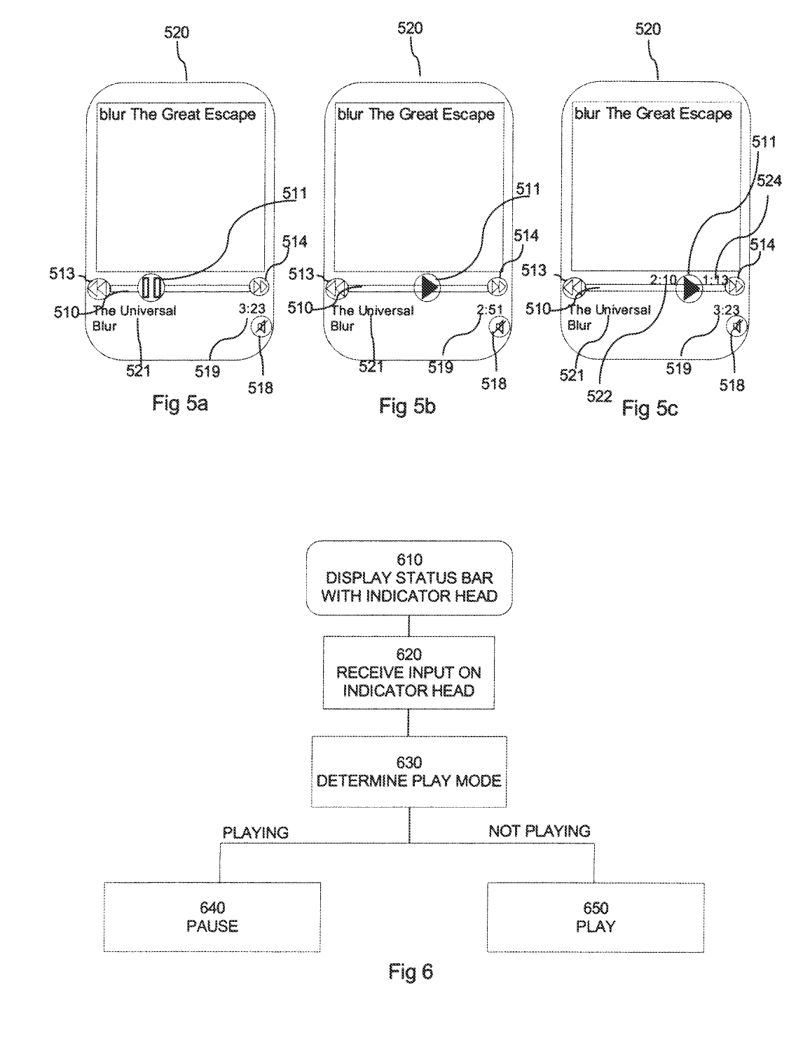

In one embodiment the status bar 410 is comprised in an application window for a media player application (see FIG. 5 for an example).

In one embodiment the status bar 410 is displayed as being superimposed on an object being displayed. In one embodiment such other object is part of an idle display view. In one embodiment such other object is part of an active idle display view.

See FIG. 4g for an example where a message text editor application window 416 is currently being displayed allwhile the status bar 410 is displayed partially superimposed on the message text editor application window 416. Various other objects 417 may also be displayed on the display 403. Examples of such objects 417 are icons associated with applications, icons associated with files, open application windows, status indicators, widgets etc.

In one embodiment the statusbar 410 is displayed semi-transparent.

In one embodiment a controller is configured to display to playback control objects 413 and 414 at the ends of the status bar 410, see FIG. 4c.

In one embodiment these playback control objects are associated with a play control function. Examples of such playback control functions are Fast Forward, Reverse, Skip Forwards and Skip Backwards. Such functions are well known to a skilled person. Other playback control functions are Change media channel, change preset media channel, tune to media channel—both manual tuning and automatic, skip to next scene, skip to previous scene, skip tot next song, skip to previous song, skip to next album, skip to previous album, skip 2, 5, 7, 10 or 15 seconds forwards, skip 2, 5, 7, or 15 seconds backwards, skip 2, 5, 7, 10 or 15 percent of the total playtime forwards, skip 2, 5, 7, or 15 percent of the total playtime backwards, skip 2, 5, 7, 10 or 15 percent of the playtime left forwards or skip 2, 5, 7, or 15 percent of the lapsed playtime backwards.

In the example of FIG. 4c the two playback control functions are Fast Forward (414) and Reverse (413) as is graphically indicated by double arrows.

The controller is configured to receive input identifying a playback control object 413, 414 and to execute the associated playback control function in response thereto.

In one embodiment a controller is configured to receive an input indicating a position 415 on the status bar 410 not corresponding to the indicator head 411.

In one example embodiment the controller is configured to skip to the indicated position that is to move the indicator head 411 to the indicated position in response thereto.

In another example embodiment the controller is configured to execute a skip command in a direction corresponding to the indicated position relative the indicator head 411. If the indicator head 411 is before the indicated position 415 as in FIG. 4d a Skip forwards function is executed. If the indicator head 411 is after the indicated position 415 a Skip backwards function is executed.

In FIG. 4d a finger 420 is used to indicate the position.

In one example embodiment the controller is configured to skip to execute a playback control action in response to receiving an input indicating a position 415 on the status bar 410 not corresponding to the indicator head 411. In one such embodiment a controller is configured to not display any play control objects 413, 414.

In another example embodiment the controller is configured to determine whether the media file is currently playing and if so to cause the playback to be paused. If it is determined by the controller that the media file is not currently playing (i.e. either paused or stopped or not started yet) the controller is configured to activate the playback. In one such embodiment the controller is further configured to move the indicator head to the position indicated and if a playback was to be activated activate the playback at the file position corresponding to the indicated position.

In one embodiment the controller is further configured to receive a drag and drop input indicating the indicator head 411 as the starting position. The controller is configured to move the current position of the playback to a location corresponding to where the indicator head is dropped.

In one embodiment the playback is activated concurrently with the drag and drop action.

In one embodiment the playback is activated as the drag and drop action is completed.

In one embodiment the controller is configured to display the indicator head 411 as being semi-transparent during the drag-and-drop action. This provides a better view of the exact position of the indicator head 411.

As has been indicated above the input can be received either as a tap input on a touch display or through the control of a display cursor which is moved to a position and then activated. FIG. 4e shows an example of how a cursor 421 controlling input means is used in a situation similar to that presented in FIG. 4d. Examples of such input means are computer mouse, joystick, track ball, touchpad etc.

In one embodiment a controller is configured to display the playback control objects 413 and 414 as being part of the indicator head 411, see FIG. 4f. In this embodiment the indicator head 411 comprises three controls, namely that of play/pause and the playback control functions associated with the playback control objects 413 and 44. By realizing that also these controls are commonly used in certain applications, such as browsing or listening through a multitude of music files, a user may benefit from the easy access to these controls being placed in close proximity to each other. This also saves space on the display.

In one embodiment a controller is configured to receive an input in the form of a touch input which has still not been released indicating a position over a control object 413, 414, the status bar, 410 or the indicator head 415, and in response thereto display a window 430 with a text indicating which action is associated. In one embodiment the controller is configured to execute the action when the touch input is released in the same position. In one embodiment the controller is configured to execute the action upon receiving a double tap. In one embodiment the controller is configured to execute the action upon receiving a longpress.

In one embodiment a controller is configured to receive an input in the form of mouse-over-event (that is a current is positioned at a certain location but the selective means are not executed) indicating a position over a control object 413, 414, the status bar, 410 or the indicator head 415 and in response thereto display a window 430 with a text indicating which action is associated. In one embodiment the controller is configured to execute the action when a selective means is used, i.e. when the position indicated is selected. This is commonly done by a mouse-click or other similar event.

FIG. 4h shows an embodiment where a window 430 is displayed as a finger is resting on the indicator head 411. In this embodiment the text “PAUSE” is displayed indicating that a PAUSE function is about to be executed.

In one embodiment a controller is configured to receive differentiating input corresponding to a same position. Examples of such differentiating inputs are short press, and long press, single click or tap and double click or tap, one point click or taps and gesture or swipes.

In one such embodiment a controller is configured to execute a first action upon receiving a first type of input indicating an object and to execute a second action upon receiving a second type of input indicting the same object.

The actions associated with each type of input are also associated with at least one object.

In one example embodiment a controller is configured to execute a PAUSE action upon receiving a single tap on the indicator head 411 while a file is being played and to execute a STOP action upon receiving a double tap on the indicator head 411 while a file is being played. In one such example embodiment the controller is configured to return the indicator head to the start of the file when executing a STOP action.

In one example embodiment a controller is configured to execute a skip action upon receiving a single tap on the status bar 410 while a file is being played and to execute a fast forwards action upon receiving a double tap on the status bar 410 while a file is being played.

In one example embodiment a controller is configured to execute a change preset channel action upon receiving a single tap on the status bar 410 while a file is being played, to execute an automatic tuning action upon receiving a double tap on the status bar 410 while a file is being played and to execute a manual tuning action upon receiving a long press on the status bar 410 while a file is being played.

In one example embodiment a controller is configured to execute a move to a specific position and pause action in response to receiving a double tap on the position and to execute a move to a specific position and continue playing action in response to receiving a single tap on the position when a file is being played.

In one example embodiment a controller is configured to execute a move to a specific position and start playback action in response to receiving a double tap on the position and to execute a move to a specific position and not start playback action in response to receiving a single tap on the position when a file is not being played, that is when the file is paused or stopped.

It should be noted that although a single tap, double tap and long press are mentioned other input types may also be used.

FIG. 5 show an application window 520 associated with an application being executed in an apparatus 500 according to the teachings herein. It should be noted that such an apparatus is not limited to a mobile phone, but can be any apparatus capable of playing media files.

Examples of such apparatuses are computers, media players, mobile phones, personal digital assistants (PDA), digital cameras, navigation devices such as GPS (Global Positioning System) devices, game consoles electronic books, Digital Video Disc players, radio sets, television sets, photo and video cameras and electronic dictionaries.

In FIG. 5a an application window 520 is shown. The application window 520 comprises a status bar 510 having an indicator head 511 and playback control objects 513 and 54. In this example the playback control objects are displayed separately but adjacent to the status bar 510.

Other control objects are also displayed such as for controlling the sound 518 along with the title 519 of the currently played file and its duration 521. The situation in FIG. 5a corresponds to that of FIG. 4b.

In FIG. 5b the same application window 520 is shown. The situation in FIG. 5b corresponds to that of FIG. 4a.

In FIG. 5c a user is currently performing a drag and drop action of the indicator head 510. As is known a drag and drop action is executed by a user marking an object and while the object is marked the user moves the control focus to another position where the object is unmarked.

Using a touch display this is most commonly used by the user pressing on an object with a finger or stylus and then moves the finger or stylus to a different position while keeping contact with the touch display. Using a cursor input means the drag and drop action is executed by a user moving the cursor to an object marking it by pressing on a selection means and then while keeping the selection means depressed moves the cursor to a different position. In FIG. 5c this is indicated by the cursor arrow 522.

In this embodiment the controller is configured to display two small windows 523 and 524 indicating the time available on each side of the position of the indicator head 510. This enables a user to find out exactly where in the media file he is currently positioning the indicator head.

In this example there is 1 min 13 seconds left and 2 minutes and 10 seconds lapsed.

In one embodiment only the lapsed time 523 is displayed.

In one embodiment only the time left 524 is displayed.

FIG. 6 shows a flowchart describing a general method as has been discussed above. In a first step 610 a status bar is displayed with an indicator head. In a second step 620 an input is received in a position corresponding to the position of the indicator head and it is determined whether a file is currently being played or not in step 630. In step 640 the file is started to play if it was not already playing and if it was already playing it is paused step 650.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, media players, personal organizers, computers or any other device designed for playing media files.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user will more quickly and efficiently identify the play control button with the position on the progress bar and thus more easily find the control without having to move over the display area. Another advantage is that it saves display space.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone and a desktop computer, it should be appreciated that the teachings of the present application may also be applied to other types of electronic devices, such as media players, video players, photo and video cameras, palmtop, laptop and desktop computers and the like. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. An apparatus comprising a controller, wherein said controller is arranged to:
display a status bar;
display an indicator head on said status bar;
receive input indicating a position corresponding to said indicator head; and to
determine if a media file is currently being played and if so pause the playback and if not to activate the playback in response to the received input.

2. An apparatus according to claim 1, wherein a position of the indicator head on the status bar corresponds to a position in the media file and wherein said controller is further configured to activate the playback at the corresponding position.

3. An apparatus according to claim 1, wherein the controller is configured to display said status bar 410 as being superimposed on another object being displayed.

4. An apparatus according to claim 3, wherein said other object is part of an idle mode display view.

5. An apparatus according to claim 1, wherein the indicator head further comprises a playback control object being associated with a playback function and a controller is configured to receive input indicating a position corresponding to said play control object and in response thereto execute said associated playback function.

6. An apparatus according to claim 1, wherein said controller is configured to receive said input through a touch display.

7. An apparatus comprising:
means for displaying a status bar;
means for displaying an indicator head on said status bar;
means for receiving input indicating a position corresponding to said indicator head; and
means for determining if a media file is currently being played and if so pausing the playback and if not activating the playback in response to the received input.

8. A user interface comprising a controller configured to:
display a status bar;
display an indicator head on said status bar;
receive input indicating a position corresponding to said indicator head; and to
determine if a media file is currently being played and if so pause the playback and if not to activate the playback in response to the received input.

9. A computer readable medium comprising at least computer program code for controlling an apparatus, said computer readable medium comprising:
software code for displaying a status bar;
software code for displaying an indicator head on said status bar;
software code for receiving input indicating a position corresponding to said indicator head; and
software code for determining if a media file is currently being played and if so pausing the playback and if not activating the playback in response to the received input.

10. A method for use in an apparatus comprising at least a processor, said method comprising:
displaying a status bar;
displaying an indicator head on said status bar;
receiving input indicating a position corresponding to said indicator head; and
determining if a media file is currently being played and if so pausing the playback and if not activating the playback in response to the received input.

11. A method according to claim 1, wherein a position of the indicator head on the status bar corresponds to a position in the media file and said method further comprises activating the playback at the corresponding position.

12. A method according to claim 1 further comprising displaying said status bar as being superimposed on another object being displayed.

13. A method according to claim 12, wherein said other object is part of an idle mode display view.

14. A method according to claim 1, wherein the indicator head further comprises a playback control object being associated with a playback function and said method further comprises receiving input indicating a position corresponding to said play control object and in response thereto executing said associated playback function.

15. A method according to claim 1 further comprising receiving said input through a touch display.
